(19) United States
(12) Patent Application Publication
(10) Pub. No.: US 2005/0142978 A1
(43) Pub. Date: Jun. 30, 2005

(54) Method of manufacturing electron-emitting source

(76) Inventors: Junko Yotani, Mie (JP); Sashiro Uemura, Mie (JP); Hiroyuki Kurachi, Mie (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/824,310

(22) Filed: Apr. 13, 2004

(30) Foreign Application Priority Data
Apr. 15, 2003 (JP) 110299/2003

(51) Int. Cl. H01J 9/04; H01J 9/12

(52) U.S. Cl. 445/50; 445/51

(57) ABSTRACT

A film (7) is formed by electrodeposition, thermal CVD, or spraying. After that, the film is irradiated with a laser beam. Carbon nanotubes that form the film (7) are disconnected by laser irradiation, so that the density of the carbon nanotubes is optimized. When the film (7) is formed in this manner, stable emission can be obtained from a cathode structure (5).

### BACKGROUND OF THE INVENTION

The present invention relates to a method of manufacturing an electron-emitting source.

Conventionally, an FED (Field Emission Display) and vacuum fluorescent display use nanotube fibers such as CNTs (Carbon NanoTubes) or CNFs (Carbon NanoFibers) as an electron-emitting source. FIG. 8 shows such CNTs. As shown in FIG. 8, conventional CNTs are formed perpendicular to a cathode substrate (see Japanese Patent Laid-Open No. 11-329312).

According to another method, CNTs as described above are formed on a cathode substrate by printing. In this case, the substrate is irradiated with a CO₂ laser or YAG laser to remove fillers and mixed fine graphite particles from the substrate surface, to expose the CNTs which form an electron-emitting source on the substrate surface (see Japanese Patent Laid-Open No. 2000-36243).

According to still another method, curled CNTs are formed on a cathode substrate by thermal CVD (see Japanese Patent Laid-Open No. 2001-229806).

When the CNTs formed on the cathode substrate have different heights, even if the differences are very small, local field concentration occurs on the tallest CNT, and emission occurs locally.

The local emission causes destruction of the CNT, leading to CNT destructions one after another. When such local field concentration and CNT destruction occur, stable emission cannot be obtained from the electron-emitting source.

When CNTs are formed on the cathode in an entangled state, an electric field cannot be easily applied to some portion of the cathode, and uniform emission cannot be obtained.

Therefore, an electron-emitting source with which stable emission can be obtained has conventionally been sought for.

### SUMMARY OF THE INVENTION

It is an object of the present invention to provide a method of manufacturing an electron-emitting source with which stable emission can be obtained.

In order to achieve the above object, according to the present invention, there is provided a method of manufacturing an electron-emitting source, comprising the steps of forming a film containing curled nanotube fibers on a substrate, and irradiating the film formed on the substrate with a laser beam perpendicularly to the substrate.

### BRIEF DESCRIPTION OF THE DRAWINGS

FIG. 1 is a sectional view of a light source tube according to an embodiment;

FIG. 2 is an electron micrograph of a film 7 generated by electrodeposition;

FIG. 3 is a graph showing the electron emission density of a cathode structure 5 before laser irradiation;

FIG. 4 is a graph showing the electron emission density of a conventional cathode structure;

FIG. 5 is an electron micrograph of the film 7 after laser irradiation;

FIG. 6 is an electron micrograph of the film 7 before laser irradiation;

FIG. 7 is a graph showing the electron emission density of the cathode structure 5 after laser irradiation; and

FIG. 8 is an electron micrograph showing the state of conventional CNTs.

### DESCRIPTION OF THE PREFERRED EMBODIMENT

The embodiment of the present invention will be described in detail with reference to the accompanying drawings.

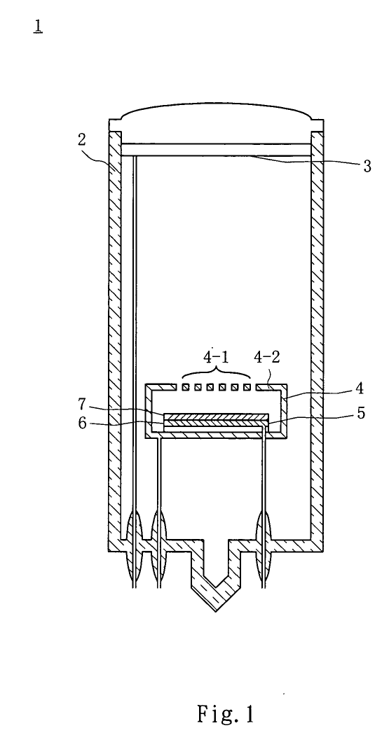

Referring to FIG. 1, a light source tube indicated by reference numeral 1 has a vacuum envelope 2 formed by fixing a transparent face glass plate to one end of a cylindrical glass tube by adhesion with low-melting frit glass, and welding, to the other end of the cylindrical glass tube, glass stems through which a plurality of lead pins are inserted and which are integrally formed with exhaust pipes. The interior of the vacuum envelope 2 is vacuum-evacuated to a pressure of about 10⁻³ Pa to 10⁻⁶ Pa.

In the vacuum envelope 2, an anode 3, on which phosphors (not shown) are deposited on its surface that opposes the face glass plate, is arranged on the end where the face glass plate is arranged. A substantially box-like gate structure 4 is formed to oppose the anode 3 such that a mesh portion 4-1 of the structure 4 faces the anode 3. A cathode structure 5 is formed in the gate structure 4 through an insulator. A voltage is applied to the anode 3, gate structure 4, and cathode structure 5 through the lead pins extracted outside the vacuum envelope 2.

The anode 3 formed of a metal substrate is set substantially parallel to the gate structure 4 and cathode structure 5.

The gate structure 4 formed of a metal substrate includes the mesh portion 4-1 and a peripheral portion 4-2 which supports the mesh portion 4-1 to be separate from the cathode by a predetermined distance.

In the cathode structure 5, a film 7 made of CNTs as an electron emitting material is formed on that surface of a cathode 6 formed of a metal substrate which opposes the gate structure 4.

The cathode 6 is made of an alloy containing iron, nickel, or the like as the main component. To form the cathode 6, iron can also be used. In this case, industrial pure iron (99.96Fe) is used. The purity of the industrial pure iron is not particularly limited, and can be, e.g., 97% or 99.9%. To form the cathode 6, for example, a 42-alloy or 42-6-alloy may be used as the alloy containing iron. However, the material of the cathode 6 is not limited to them.

In this embodiment, the cathode 6 has meshes having hexagonal structures with a pitch of 450 μm and a line width of 80 μm. The openings of the through holes of the meshes can have any shapes as far as they uniform the distribution of the film on the metal substrate, and the sizes of the openings need not be equal. For example, the shape of each opening may be a polygon such as a triangle, quadrangle, or hexagon, a shape obtained by rounding the corners of such polygon, or a circle or ellipse. The sectional shape of a portion between adjacent through holes of the metal portion is not limited to a square, but can be, e.g., a circle or ellipse formed of curves, a polygon such as a triangle, quadrangle, or hexagon, or a shape obtained by rounding the corners of such polygon.

How to form the film 7 on the cathode 6 will be described. The film 7 can be manufactured by electrodeposition, thermal CVD, spraying, or the like.

First, a CNT forming method in accordance with electrodeposition will be described.

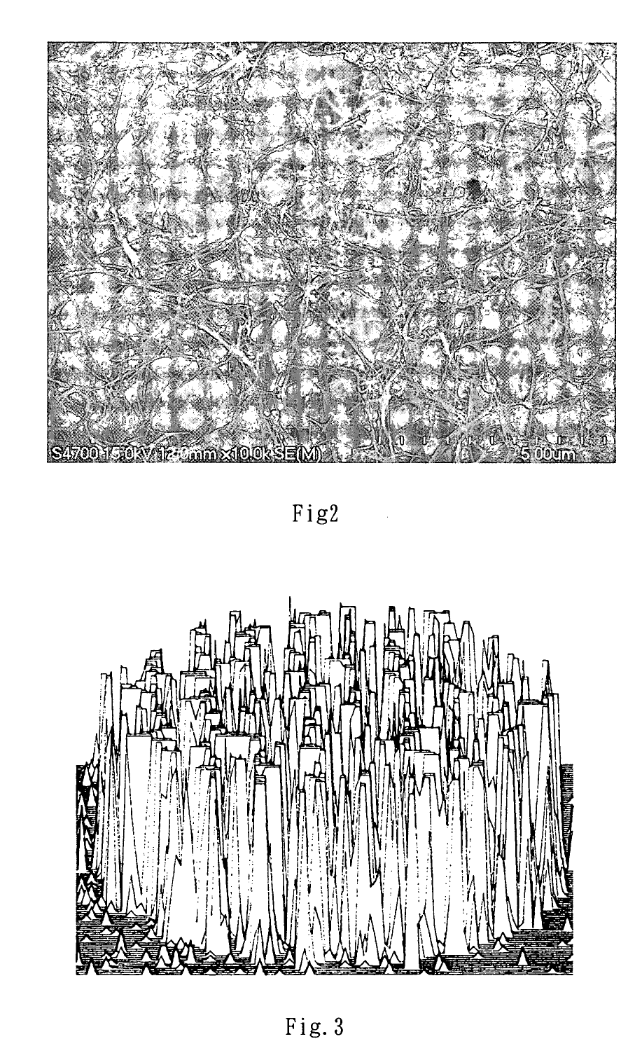

One hundred mg of CNT generated by arc discharge or the like are refluxed in nitric acid to remove impurities such as a catalyst metal. The obtained material is put in 100 cc of isopropyl alcohol (IPA). An electrodeposition solution in which CNTs are uniformly dispersed in IPA using ultrasonic wave or a surfactant is fabricated. The cathode 6 and a counterelectrode made of stainless steel are set in the electrodeposition solution to be parallel to each other at a gap of 10 mm, and a voltage of 50 V is applied to them for 1 min. After applying the voltage, the metal substrate is extracted from the electrodeposition solution and dried. A film 7 as shown in FIG. 2 is thus formed on the cathode 6.

Each of the nanotube fibers which form the film 7 is a material made of carbon and having a thickness of about 1 nm or more to less than 1 μm and a length of about 1 μm or more to less than 100 μm, and is formed of a carbon nanotube. The carbon nanotube may have a single-layer structure in which a single graphite layer is cylindrically closed and a five-membered ring is formed at the distal end of the cylinder. The carbon nanotube may have a coaxial multi-layer structure in which a plurality of graphite layers form a telescopic layered structure with the respective graphite layers being closed cylindrically. The carbon nanotube may be a hollow graphite tube having a disordered defective structure, or a graphite tube filled with carbon. Alternatively, a structure in which the above-mentioned carbon nanotubes are mixed may be used. Each nanotube fiber may have one end connected to the surface of a plate-like metal member or the wall of a through hole, and curved or entangled with one end of another nanotube fiber, as shown well in FIG. 2, to cover a metal portion which forms a lattice, thus forming a fluffy film. In this case, the film 7 covers the cathode 6 to a thickness of about 5 μm and forms a smooth curved surface.

A CNT forming method in accordance with thermal CVD will now be described.

The cathode 6 is put in a reaction vessel, and the interior of the vessel is evacuated to a vacuum state. After that, carbon monoxide gas and hydrogen gas are introduced into the vessel at rates of 500 sccm and 1,000 sccm, respectively, to maintain the interior of the vessel at 1 atm. The plate-like metal member is heated at 550° C. to 600° C. for 30 min with an infrared lamp. A film 7 identical to that formed above by electroplating is formed on the cathode 6.

A method of forming the film 7 in accordance with spraying will be described.

A solution in which CNTs are uniformly dispersed in IPA is fabricated in the same manner as in electrodeposition. The fabricated solution is sprayed by an air brush to the cathode 6 away from the blowing port of an air brush by about 10 cm with an air pressure of 0.1 MPa. The substrate may be preheated so that the solution can evaporate readily. Then, a film 7 identical to that formed by electrodeposition or thermal CVD described above is formed on the cathode 6.

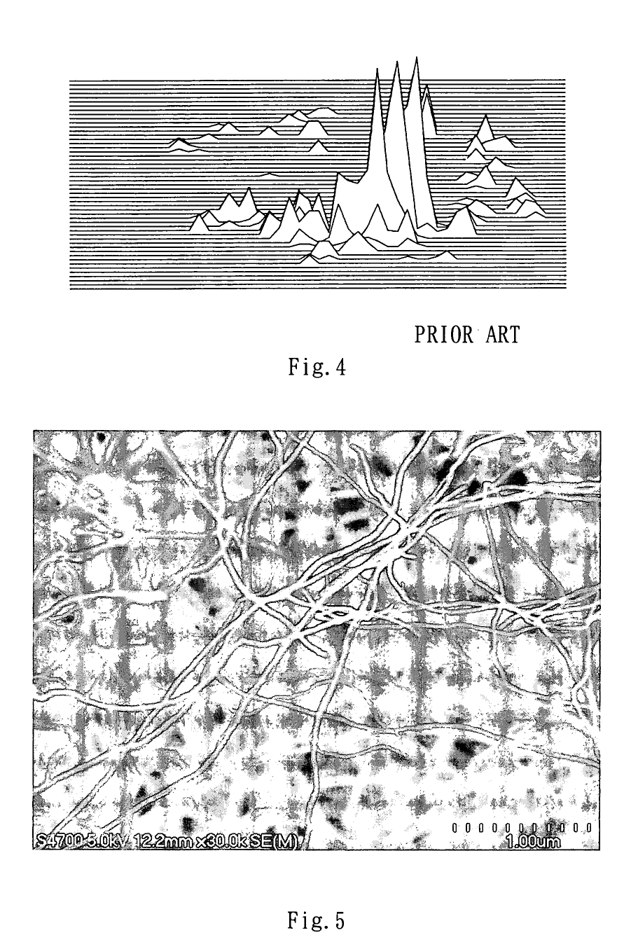

FIG. 3 shows a result obtained by measuring the electron emission uniformity of the cathode structure 5 formed in the above manner. With reference to FIGS. 3 and 4, a comparison will be made on the electron emission density between the cathode structure of this embodiment and the conventional cathode structure. FIGS. 3 and 4 show the electron emission uniformity of the cathode structure in the form of the current density measured at measurement points formed at a 40-μm intervals both in the X and Y directions. In FIGS. 3 and 4, the peaks are leveled at 0.1 mA/cm².

In the cathode structure shown in FIG. 4 in which CNTs are formed perpendicularly, as the CNTs have different heights, emission occurs locally.

In the cathode structure 5 of this embodiment before laser irradiation shown in FIG. 3, the CNTs are curled or entangled with each other to form the fluffy film 7. As the film 7 has a smooth surface, an electric field is uniformly applied to the entire cathode structure 5. Consequently, emission occurs from the entire cathode structure 5.

In this manner, according to this embodiment, since the fluffy film 7 is formed, emission occurs from the entire cathode structure 5, so that stable emission can be obtained.

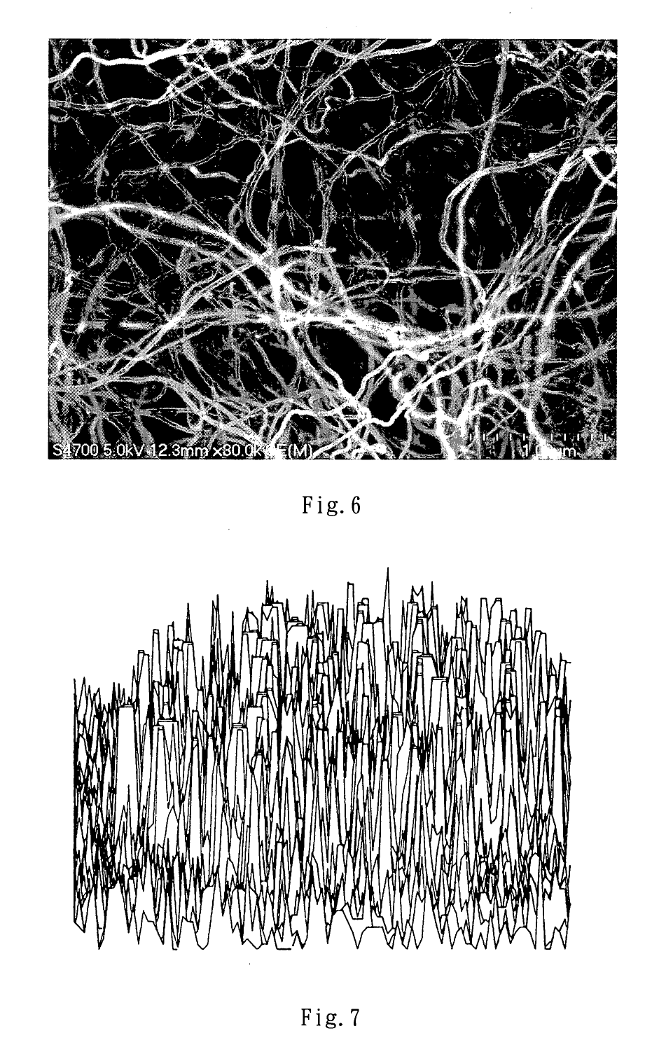

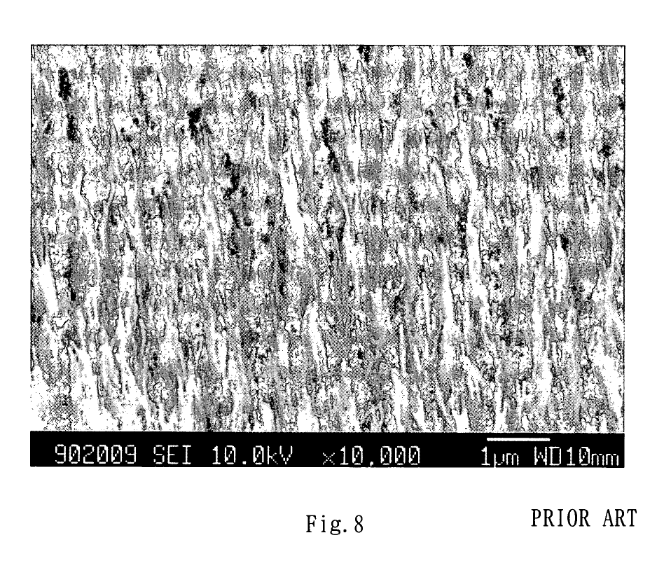

According to this embodiment, after the film 7 is formed in accordance with the method described above, the film is irradiated with a laser beam. The laser irradiation is performed in a gas atmosphere such as air or nitrogen, or in vacuum. The laser has an energy density of 5 mJ/cm² to 500 mJ/cm², and preferably about 10 mJ/cm² to 150 mJ/cm². Hence, as the laser, an excimer laser such as XeCl laser or KrF laser can be used. Such a laser is scanned on the entire film 7 in a direction perpendicular to that surface of the cathode 6 where the film 7 is arranged, with the pitch corresponding to the diameter of the beam, to uniformly irradiate the film 7 entirely or partly. Thus, a film as shown in FIG. 5 is formed.

The state of the film 7 before laser irradiation and that after laser irradiation will be described with reference to FIGS. 5 and 6. The films 7 shown in FIGS. 5 and 6 are formed by thermal CVD.

In the film 7 after laser irradiation shown in FIG. 5, the CNTs are disconnected by laser irradiation. Thus, the density of the CNTs is small and the number of CNT ends is large.

In the film 7 before laser irradiation shown in FIG. 6, the CNTs are dense. As each CNT is long, the number of CNT ends which form an electron-emitting source is small.

With reference to FIGS. 3 and 7, a comparison will be made on the electron emission uniformity between the film 7 before laser irradiation and that after laser irradiation. FIGS. 3 and 7 show the result of an experiment performed under the same conditions, each exhibiting the electron emission uniformity of the cathode structure in the form of the current density measured at measurement points formed at 40-μm intervals both in the X and Y directions. In FIGS. 3 and 7, the peaks are leveled at 0.1 mA/cm² for the convenience of the display screen. Therefore, those portions in FIGS. 3 and 7 where the upper portion or upper end of the graph is indicated as a flat portion, i.e., a horizontal straight line, signify that the current density exceeds 0.1 mA/cm².

In FIG. 3 (before laser irradiation), the upper end of the graph is flat at more portions than in FIG. 7 (after laser irradiation). As the peaks are leveled at 0.1 mA/cm² as described above, in FIG. 3, the current density of the cathode structure 5 before laser irradiation exceeds 0.1 mA/cm² at many portions. According to the experimental result, the maximum current density is 3.84 mA/cm² before laser irradiation and 0.37 mA/cm² after laser irradiation. The maximum current density is low after laser irradiation by about an order of magnitude. In the cathode structure 5 after laser irradiation, the CNTs are disconnected, so that the surface of the film 7 is formed with a uniform height. Hence, local field concentration can be prevented, and stable emission can be obtained.

According to the experimental result, the total current flowing through the cathode structure 5 is 1.72 mA before laser irradiation and 1.65 mA after laser irradiation, which current values are almost equal to each other. As described above, the maximum current density changes through laser irradiation, but the total current is almost the same before and after laser irradiation. According to this result, in the cathode structure 5 after laser irradiation, as the CNTs are disconnected by the laser, the number of CNTs that form emission sites increases, and uniform emission can be obtained from the entire film 7.

According to the experimental result, a voltage necessary for obtaining the same current amount (total current) is 945 V before laser irradiation and 725 V after laser irradiation. The voltage is lower after laser irradiation. This is related to the CNT density of the film 7. More specifically, if the CNT density is high, the CNTs for forming the film 7 which covers the ends of the CNTs serving as the emission sites interfere with an electric field necessary for emission from being applied to the vicinities of the ends. Therefore, electrons cannot be extracted from the cathode structure 5 before laser irradiation, which has a high CNT density, unless a high voltage is applied. In the cathode structure 5 after laser irradiation, the CNTs are disconnected by laser irradiation, and the CNT density is optimized. Thus, electrons can be extracted from the cathode structure 5 with a low voltage.

As has been described above, according to the present invention, when a film arranged on the substrate and formed of curled nanotube fibers is irradiated with a laser beam, the surface of the film is formed with a uniform height. Thus, local field concentration can be prevented, and stable emission can be obtained. Since the number of ends of nanotube fibers that form emission sites increases, uniform emission can be obtained from the entire film. Since the nanotube fibers are disconnected by laser irradiation and the density of the nanotube fibers is optimized, emission can be obtained with a low voltage as well.

1. A method of manufacturing an electron-emitting source, comprising the steps of:
forming a film containing curled nanotube fibers on a substrate; and
irradiating the film formed on the substrate with a laser beam perpendicularly to the substrate.

2. A method according to claim 1, wherein the step of forming includes the step of forming a film of the nanotube fibers made of carbon.

3. A method according to claim 1, wherein the step of forming includes the step of forming the film in accordance with any one scheme selected from electrodeposition, thermal CVD, and spraying.

4. A method according to claim 1, wherein the step of forming includes the step of forming the film on the substrate made of iron or an iron-containing alloy.

5. A method according to claim 1, wherein the step of irradiating includes the step of irradiating with the laser at an energy density of 5 mJ/cm² to 500 mJ/cm².

6. A method according to claim 1, wherein the step of irradiating includes the step of irradiating the film with an excimer laser as the laser.

7. A method according to claim 1, wherein the step of irradiating includes the step of irradiating the film with the laser in any one atmosphere selected from air, gas, and vacuum.
